(19) United States
(12) Patent Application Publication
(10) Pub. No.: US 2022/0349984 A1
(43) Pub. Date: Nov. 3, 2022

(54) LOW POWER RADAR IN RADIO COMMUNICATION TERMINAL

(71) Applicant: SONY GROUP CORPORATION, Tokyo (JP)

(72) Inventors: Kåre AGARDH, Rydebäck (SE); Erik BENGTSSON, Eslöv (SE); Olof ZANDER, Södra Sandby (SE); Fredrik RUSEK, Eslöv (SE); Thomas BOLIN, Lund (SE)

(21) Appl. No.: 17/604,406

(22) PCT Filed: May 5, 2020
(86) PCT No.: PCT/EP2020/062457

§ 371 Date: Oct. 16, 2021

(30) Foreign Application Priority Data
Jun. 14, 2019 (SE) 1950721-9

(51) Int. Cl. G01S 7/00; G01S 13/87; G01S 7/02

(52) U.S. Cl. CPC G01S 7/006; G01S 13/87; G01S 7/0235; G01S 7/0232

(57) ABSTRACT

A radio communication terminal (UE1) configured to act as a radar device, comprising a wireless communication chipset (313) including a transmitter (314) and a receiver (315), and logic (310) configured to control the wireless communication chipset to communicate on a radio channel (120) in a wireless communication system; execute radar probing (130) during a probing period, including to transmit a radar signal (140) using the transmitter and sense receive properties of a reflection (150) of the radar signal using the receiver; inhibit transmission of communication signals from the communication terminal during said probing period; and receive communication signals on the radio channel during said probing period.

### TECHNICAL FIELD

This disclosure relates to the concept of using a radio communication terminal, configured to communicate in a radio communication system, to operate as a radar probing device. Specifically, solutions are provided for configuring a radio communication terminal to use the same wireless communication chipset for communication and for radar probing.

### BACKGROUND

For achieving higher data bandwidth, the spectrum used for communication on radio channels is expected to move to higher frequencies, e.g., to frequencies beyond 6 or 10 GHz. At such frequencies, radar probing is feasible. This is due to the well-defined spatial transmission characteristics of electromagnetic waves in the respective spectrum. Moreover, a radio communication terminal configured to operate in a radio communication system at these frequencies may be equipped with an antenna array, making the terminal capable of spatial filtering or beam forming in different directions.

In radar probing using a unitary radar device, a radar receiver measures properties of radio frequency echoes from signals or pulses transmitted by a radar transmitter. Based on the received signal properties, and of the transmitted signal, calculations may be made to compute relative distances to, and velocities of, reflecting objects. If the radar device knows its position, velocity, and orientation, it is possible to compute the absolute position and velocity also for the reflecting object.

One problem associated with using a radio communication terminal for radar probing is that the wireless communication chipset is inherently adapted to transmit and receive signals of the same character as used for data signaling in the wireless communication system, such as to and from a base station. As a result, interference caused by communication signaling may be detrimental to the possibility to reliably carry out radar probing.

One prior art document discussing the use of a wireless communication chipset in a communication terminal for radar probing is described in WO2018/222268A1. This document discusses a wireless communication chipset including an in-phase and quadrature modulator, configured to modulate a radar signal based on linear-frequency modulation to enable detection of a target that reflects the modulated radar signal.

However, when considering using a wireless communication chipset in a communication terminal for radar probing there still exists a risk for emitted radar signals causing interference or saturation in the receiver of the terminal, or other terminals, thereby disturbing the capability of wireless communication during the radar probing.

### SUMMARY

Therefore, a need exists for techniques of coexistence of communication signaling and radar probing. In particular, a need exists for improvements in the endeavor to allow radar probing using a wireless communication chipset adapted for communication signaling, without the radar probing and the communication signaling disturbing or disrupting each other.

This need is met by the features of the independent claims. The features of the dependent claims define embodiments.

According to one aspect, a radio communication terminal is configured to act as a radar device, and comprises
a wireless communication chipset including a transmitter and a receiver,
logic configured to control the wireless communication chipset to:

communicate on a radio channel in a wireless communication system, with a transmit power exceeding a threshold power level;
execute radar probing during a probing period (TP), including to transmit a radar signal using the transmitter and sense receive properties of a reflection of the radar signal using the receiver;
inhibit transmission of communication signals from the communication terminal during said probing period; and
receive communication signals on the radio channel during said probing period. Thereby, it becomes possible to employ execute radar probing with the terminal, using the same chipset, without risking saturation of the receiver.

According to another aspect, an access node in a network of wireless communication system is provided, comprising:
a wireless transceiver for communicating with a radio communication terminal,
logic configured to control the wireless transceiver to
   configure the radio communication terminal to transmit communication signals according to a first scheme;
   detect a request, from the radio communication terminal, to execute radar probing during a probing period;
   configure the radio communication terminal to transmit communication signals according to a second scheme, responsive said request, wherein said second scheme is adapted to allow radar probing by transmission and reception in the terminal during said probing period; and
   transmit communication signals to the radio communication terminal during said probing period. By configuring the terminal to employ a different scheme for transmission during the probing period, in which no transmission or more scares transmission is scheduled for the terminal, the access node may assist the terminal to employ execute radar probing using the same chipset as for communication, without risking saturation of the receiver.

Further aspects and advantages of various embodiments are set out in the claims and in the following description.

### BRIEF DESCRIPTION OF THE DRAWINGS

FIG. 1 schematically illustrates a scenario of radar probing using a radio communication terminal of a radio communication network according to various embodiments.

FIG. 2 schematically illustrates coexistence of data communication and radar probing according to various embodiments.

FIG. 3A schematically illustrates a radio communication terminal configured to act as a radar transmitter according to various embodiments.

FIG. 3B schematically illustrates an access node configured to support and communicate with a terminal acting as a radar transmitter according to various embodiments.

FIG. 4 schematically illustrates receive properties of radar probe pulses received by an antenna array of a radio transceiver according to various embodiments.

FIG. 5 schematically illustrates resource mapping of a radio channel employed for the data communication according to various embodiments.

FIG. 6 schematically illustrates resource mapping of a radio channel employed for the data communication according to various embodiments, wherein uplink resources are mapped to allow for radar probing by the terminal within the time and frequency spectrum of the wireless communication system, and an indication of power levels for radio communication signaling and for radar probing, respectively.

FIG. 7 schematically illustrates resource mapping of a radio channel employed for the data communication according to various embodiments, wherein uplink resources are skipped or postponed pending radar probing.

FIG. 8 schematically illustrates start and end of a radar probing period.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques for allowing coexistence of data communication and radar probing are described, using a wireless communication chipset in a radio communication terminal.

Radar probing can be used for a variety of cases, include for example positioning aid, traffic detection, drone altitude detection and landing assistance, obstacle detection, security detection, photography features, gesture tracking, indoor positioning etc.

To facilitate the coexistence, one or more resource mappings may be employed to coordinate and distribute resource-usage between the data communication and the radar probing. The one or more resource mappings may define resource elements with respect to one or more of the following: frequency dimension; time dimension; spatial dimension; and code dimension. Sometimes, the resource elements are also referred to as resource blocks. Resource elements may thus have a well-defined duration in time domain and/or bandwidth in frequency domain. The resource elements may be, alternatively or additionally, defined with respect to a certain coding and/or modulation scheme. A given resource mapping may be defined with respect to a certain spatial application area or cell. In some examples, communication may be carried out on a radio channel in a wireless communication system, with a transmit power exceeding a threshold power level. Moreover, radar probing may be executed using the same radio transceiver, including to transmit a radar signal and sense receive properties of a reflection of the radar signal, with a transmit power below said threshold power level. In other words, it becomes possible to employ one and the same hardware to perform both data communication and radar probing. By employing the radar probing in the context of a device configured for data communication, the functionality of that device can be greatly enhanced.

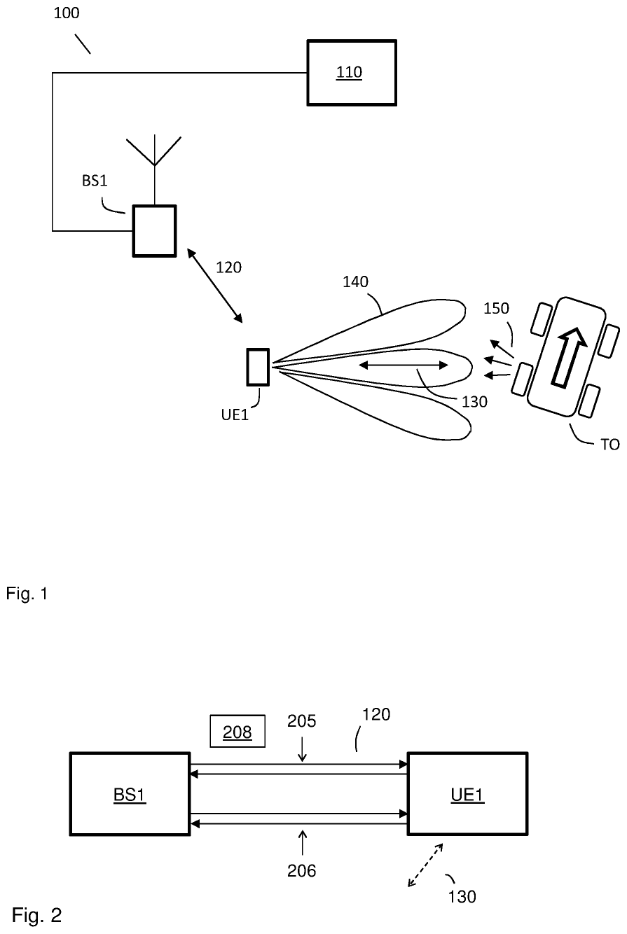

FIG. 1 illustrates a high-level perspective of radar probing in a radio communication network 100 according to various embodiments outlined herein. The radio communication network 100 may comprise a core network 110 and one or more base stations, of which one base station BS1 is illustrated. The base station BS1 is configured for wireless communication 120 with various terminals, of which a first radio communication terminal UE1 is shown, also referred to as terminal for short herein. Such terminals may be selected from the group comprising: handheld device; mobile device; robotic device; smartphone; laptop; drone; tablet computer; wearable devices, IoT (Internet of Things) devices, smart meters, communication modems/access points, navigation devices (GPS units), cameras, CAM recorder etc.

Wireless communication may include data communication defined with respect to a radio access technology (RAT). While with respect to FIG. 1 and the following FIGS., various examples are provided with respect to a cellular network, in other examples, respective techniques may be readily applied to point-to-point networks. Examples of cellular networks include the Third Generation Partnership Project (3GPP)—defined networks such as 3G, 4G and upcoming 5G. Technology-wise, the network may for example use a WCDMA, LTE or New Radio access protocol. Examples of point-to-point networks include Institute of Electrical and Electronics Engineers (IEEE)—defined networks such as the 802.11ax Wi-Fi protocol or the Bluetooth protocol. As can be seen, various RATs can be employed according to various examples.

The scenario of FIG. 1 is based on the notion that there is an interest of knowing physical properties about an object, herein also referred to as a target object (TO). It should be understood that the underlying objective does not necessarily have to be directed to the TO, but to obtaining information of presence or activity in a certain location area, in which an object may currently be located. The interest of obtaining knowledge of the physical properties about the TO may originate from a terminal, e.g. UE1, or from other entities of the system, e.g. presence detectors, an operator, a default schedule, etc.

To obtain knowledge of the physical properties about the TO, radar probing is carried out, in which the terminal is configured to act as a radar transmitter to transmit radio signals in form of radar probing pulses, and to act as a radar receiver to sense receive properties of echoes of such radio signals. The received echoes may subsequently be processed in order to obtain the physical properties about the TO, such as location, shape, velocity etc. The transmission in this context means that the terminal is configured to transmit a predefined signal shape, e.g. a pilot or a beam sweep of pilots, that can be used for radar operation, or of a character or using one or more radio resources which can be recognized in the received echo. A receiver in the UE1 is configured to listen for the transmitted radar signal to sense receive properties of echoes. Signal properties of the received signal echoes may then be analyzed to determine properties of the object from which the echoes originated, such as the target object TO. The signal properties may include time of arrival, direction of arrival, power level etc. of the signal.

Now referring to FIG. 2, an example scenario of coexistence between radar probing 130 and data communication 208—such as packetized data communication—is depicted. Here, the base station BS1 of e.g. a cellular network 100 implements the signal and data communication 208 with the terminal UE1 attached to the cellular network 100 via a radio channel 120.

Communicating data may comprise transmitting data and/or receiving data. In the example of FIG. 2, the data communication 208 is illustrated as bidirectional, i.e. comprising uplink (UL) communication and downlink (DL) communication. The data communication 208 may be defined with respect to a RAT, comprising a transmission protocol stack in layer structure. E.g., the transmission protocol stack may comprise a physical layer (Layer 1), a datalink layer (Layer 2), etc. Here, a set of rules may be defined with respect to the various layers which rules facilitate the data communication. E.g., the Layer 1 may define transmission blocks for the data communication 208 and pilot signals. The data communication 208 is supported by, both, the base station BS1 as well as the terminal UE1. The data communication 208 employs a shared channel 205 implemented on the radio channel 120. The shared channel 206 comprises an UL shared channel and a DL shared channel. The data communication 208 may be used in order to perform uplink and/or downlink communication of application-layer user data between the base station BS1 and the terminal UE 1. As illustrated in FIG. 2, furthermore, a control channel 206 is implemented on the radio channel 120. Also, the control channel 206 is bidirectional and comprises an UL control channel and a DL control channel. The control channel 206 can be employed to implement communication of control messages. E.g., the control messages can allow to set up transmission properties of the radio channel 120.

Both performance of the shared channel 205 as well as performance of the control channel 206 are monitored based on pilot signals. The pilot signals, sometimes also referred to as reference signals or sounding signals, can be used in order to determine the transmission characteristics of the radio channel 120. In detail, the pilot signals can be employed in order to perform at least one of channel sensing and link adaptation. Channel sensing can enable determining the transmission characteristics such as likelihood of data loss, bit error rate, multipath errors, etc. of the radio channel 120. Link adaptation can comprise setting transmission properties of the radio channel 120 such as modulation scheme, bit loading, coding scheme, etc. The pilot signals may be cell-specific.

The radar probing 130 can be used in order to determine the position and/or velocity of passive objects in the vicinity of the terminal UE1. It is possible that the position of the passive objects TO is determined in terms of a distance to the radar transmitter. Alternatively, or additionally, it is possible that the position is more accurately determined, e.g., with respect to a reference frame. Radial and/or tangential velocity may be determined. For this, one or more receive properties of echoes of the radar probe pulses can be employed as part of the radar probing. Echoes are typically not transmitted along a straight line, hereinafter for simplicity referred to as non line-of-sight (LOS), but affected by reflection at the surface of an object. The receive properties may be locally processed in the terminal UE1. The radar transmitter, which is realized by configuration of radio communication terminal UE1, is configured to transmit radar probe pulses. Likewise, the radar receiver, which is realized by configuration of the terminal UE1, is configured to receive echoes of radar probe pulses reflected from passive objects. This may include transmitting a pre-defined signal using a certain beamformer, and possibly at a certain power level such as not exceeding a power limit. This may thus include transmitting, and receiving, radio signals that are similar or identical to radio communication signals in the wireless system, but at a power level which is below what will be considered as communication signals in the wireless communication system. Additionally, or optionally, this may include transmitting radio signals for radar probing purposes in resources which are not scheduled for communication signalling from the terminal by an access node of the wireless communication system.

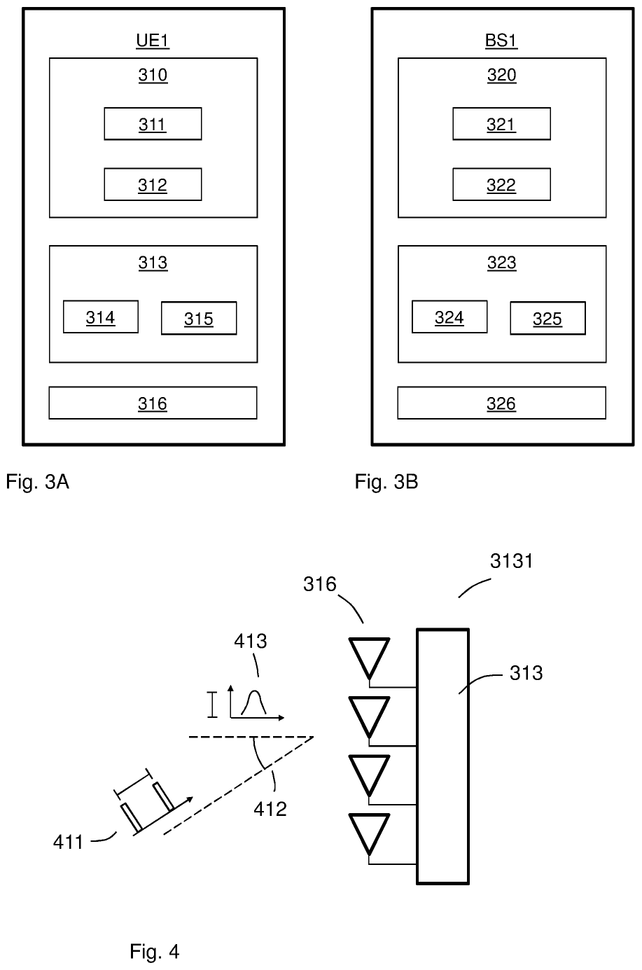

FIG. 3A schematically illustrates a radio communication terminal UE1 for use in a radio communication network 100 as presented herein, and for carrying out the method steps as outlined, configured to act as a radar transmitter and a radar receiver. This embodiment is consistent with the scenario of FIG. 1.

The terminal UE1 may comprise a wireless chipset 313 including a radio transceiver for communicating with other entities of the radio communication network 100, such as the base station BS1. The wireless chipset 313 may thus include a radio transmitter 314 and a radio receiver 315 for communicating through at least an air interface on a radio channel 120.

The terminal UE1 further comprises logic 310 configured to communicate data via the radio transceiver on the radio channel 120, to the wireless communication network 100 and possibly directly with other terminals by Device-to Device (D2D) communication, such as in sidelink communication. In various embodiments, the logic 310 forms part of the chipset 313.

The logic 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the terminal UE1 to carry out any of the method steps as provided herein. Software defined by said computer program code may include an application or a program that provides a function and/or a process. The software may include device firmware, an operating system (OS), or a variety of applications that may execute in the logic 310.

The terminal UE1 may further comprise an antenna 316, such as an antenna array 316. The logic 310 may further be configured to control the radio transceiver to employ an anisotropic sensitivity profile of the antenna array 316 to transmit radio signals in a particular transmit direction. The terminal UE1 may further comprise other elements or features than those shown in the drawing or described herein, such as a positioning unit, a power supply, a casing, a user interface etc.

FIG. 3B schematically illustrates an access node BS1 of the radio network 100 adapted to wirelessly communicate with communication terminal, such as the terminal UE1, and configured for carrying out the associated method steps as outlined. This embodiment is consistent with the scenario of FIG. 1.

The access node BS1 may comprise a wireless transceiver 323 for communicating with other entities of the radio communication network 100, such as the terminal UE 1. The wireless transceiver 323 may thus include a radio transmitter 324 and a radio receiver 325 for communicating through at least an air interface on a radio channel 120.

The access node BS1 further comprises logic 320 configured to communicate data via the wireless transceiver 323 on the radio channel 120 to terminals including UE1.

The logic 320 may include a processing device 321, including one or multiple processors, microprocessors, data processors, co-processors, and/or some other type of component that interprets and/or executes instructions and/or data. Processing device 321 may be implemented as hardware (e.g., a microprocessor, etc.) or a combination of hardware and software (e.g., a system-on-chip (SoC), an application-specific integrated circuit (ASIC), etc.). The processing device 321 may be configured to perform one or multiple operations based on an operating system and/or various applications or programs.

The logic 320 may further include memory storage 322, which may include one or multiple memories and/or one or multiple other types of storage mediums. For example, memory storage 322 may include a random access memory (RAM), a dynamic random access memory (DRAM), a cache, a read only memory (ROM), a programmable read only memory (PROM), flash memory, and/or some other type of memory. Memory storage 322 may include a hard disk (e.g., a magnetic disk, an optical disk, a magneto-optic disk, a solid state disk, etc.).

The memory storage 322 is configured for holding computer program code, which may be executed by the processing device 321, wherein the logic 320 is configured to control the access node BS1 to carry out any of the method steps as provided herein. Software defined by said computer program code may include an application or a program that provides a function and/or a process. The software may include device firmware, an operating system (OS), or a variety of applications that may execute in the logic 320.

The access node BS1 may further comprise or be connected to an antenna 326, such as an antenna array 326. The logic 320 may further be configured to control the wireless transceiver 323 to employ an anisotropic sensitivity profile of the antenna array 326 to transmit radio signals in a particular transmit direction.

FIG. 4 schematically illustrates a transceiver arrangement 3131 of the terminal UE1 in one embodiment. It may be noted that a corresponding arrangement may be employed in a transmitting terminal UE 1. The transceiver arrangement 3131 comprises an antenna array 316 in the illustrated example, connected to the wireless chipset 313. Based on the antenna array 316, it is possible to employ an anisotropic directional transmission profile of the respective radar probe pulse, and/or an anisotropic sensitivity profile during reception, e.g., of an echo of a radar probe pulse. In some examples, it is possible that the accuracy of the radar probing is further increased by employing an anisotropic sensitivity profile of the antenna array 316 of the radio transceiver arrangement 3131. FIG. 4 furthermore schematically illustrates receive properties such as the receive power level 413, the angle of arrival 412, and the time-of-flight 411.

In accordance with the solutions proposed herein, radar probing 130, or operation, is carried out in the terminal UE1 using the same wireless chipset 313 as for communication signaling and data transmission 120, but in a manner that radar probing 130 does not disturb communication signaling 120, and preferably such that communication signaling 120 does not disturb radar probing 130. This may be obtained by executing radar probing 130 at a miniscule transmit power level. The transmitted radar signals or sweeps can have a power that is on par with, or lower than, a transmit power level, e.g. a transmit OFF power as defined by 3GPP specification TS 36.101 section 6.3.3.1, which may be referred to as a noise level. The transmit power level may be dependent on channel bandwidth. In some embodiments, the transmit power level may be −50 dBm.

The radio communication terminal UE1 is thus configured to act as a radar device, comprising the wireless communication chipset 313 including the transmitter 314 and the receiver 315, and the logic 310 configured to control the wireless communication chipset.

In various embodiments, the logic 310 is configured to control the wireless communication chipset 313 to communicate on the radio channel 120 in a wireless communication system, such as with the network 100, with a transmit power Pc exceeding a threshold power level P1. Moreover, the logic 310 is configured to control the wireless communication chipset 313 to execute radar probing 130 during a probing period (TP), including to transmit a radar signal 140 using the transmitter 314 and sense receive properties of a reflection 150 of the radar signal using the receiver 315. The logic 310 may further be configured to control the wireless communication chipset 313 to inhibit transmission of communication signals from the communication terminal during said probing period, as further outlined below.

In various embodiments, the radar signal 140 is transmitted with a power Pr, or spectral density, that is below said threshold power level P1. In some embodiments, the threshold power level P1 is defined by a limitation P1A for spurious emissions set by authorities, such as FCC (Federal Communications Commission). In some embodiments, the radar signal 140 is transmitted with a power Pr, or spectral density, that is below a limit P1B set by a definition in a technical specification, such as by 3GPP or ETSI, wherein said limit sets a lower level for data or signal communication in the network 100, e.g. from the terminal UE1 and the base station BS1. In various embodiments, the threshold power level P1 is the power level P1B for the Transmit OFF power, as given above. As a result of the low transmit power, the radar signal can be transmitted at will, since it does not violate any regulatory or specified power levels, thereby creating negligible interference to the network 100.

The low power level Pc limits the operational range, e.g. to some 10ths of meters, and may limit the maximum detectable velocity to a few m/s. However, in several use cases, these limitations do not pose any problem, e.g. gesture tracking, indoor positioning, drone altitude detection etc. This is so since the slow process allows for long observation times which give sufficiently good SNR although the signal may be below or on par with the noise floor. In various embodiments, the range may be up to 100 m.

Executing radar probing at a low transmit power level Pr has a further advantageous effect. When using a 2-port radio transceiver functionality in the wireless chipset 313, one port acting as transmitter 314 and one acting as receiver 315, advanced methods are normally needed in order to provide sufficient isolation and avoiding saturation. This is not needed using the solution proposed herein, confirmed to an output power Pr below that of spurious emissions P1 or specified minimum transmission levels P2. The low power level Pr enables full duplex, i.e. simultaneous transmit and receive, without saturating the receiver and therefore a more complicated and costly duplexer system is not needed. As the radar transmissions operate at or near noise-level they will not cause interference to other terminals and can be operated without any network coordination.

In various embodiments, the synthesized signal transmitted as a radar signal 140 is modulated with a known pseudo random pattern, distributed over time and frequency. As the receiver 315 is configured in the same wireless chipset as the transmitter 314, the pattern is known and the wireless chipset has the possibility to correlate the received noise+signal with the same sequence as transmitted, and thereby sense receive properties of the radio signal echoes.

To achieve an SNR that enables high quality estimation of receive signal properties, repetition in time and/or frequency may be obtained during radar probing 130. There may therefore exist a compromise between time and frequency resource allocation of the transmitted signal to aggregate enough energy for the signal to be detectable, and the radar range or radar sweep rate. Different usage scenarios may require different time/frequency allocations which therefore may be flexible.

Dependent on the power level Pr, and of the magnitude of the received radar echoes, a large number of transmission repetitions may be required, such as tens or hundreds of repetitions, or more than 1000 repetitions. These repetitions may be distributed in both time and frequency. In addition, these repetitions should not be distributed over a too long time period, at least if radar probing of a moving object TO is intended, where position, velocity and direction may otherwise change during a probing period and return a false result. For this reason, radar probing by repetition in time of transmission of radar signals is in various embodiments carried out in consecutive, or near consecutive, time slots.

In some embodiments, the logic 310 is configured to control the wireless communication chipset 313 to execute radar probing during a probing period TP and inhibit transmission of communication signals in a wireless communication system during said probing period. In the context of various embodiments, inhibiting may include the terminal skipping or postponing any data destined for transmission, e.g. as provided in a buffer of the terminal. This may include avoiding sending a buffer report during the probing period. In some embodiments, inhibiting may include signaling a message to the network 100 to request that transmission from the terminal, in the uplink or side link, is not scheduled during the probing period. In various embodiments, the wireless communication system may be a 3GPP 2G, 3G, 4G, 5G or other, or e.g. a IEEE Wifi system.

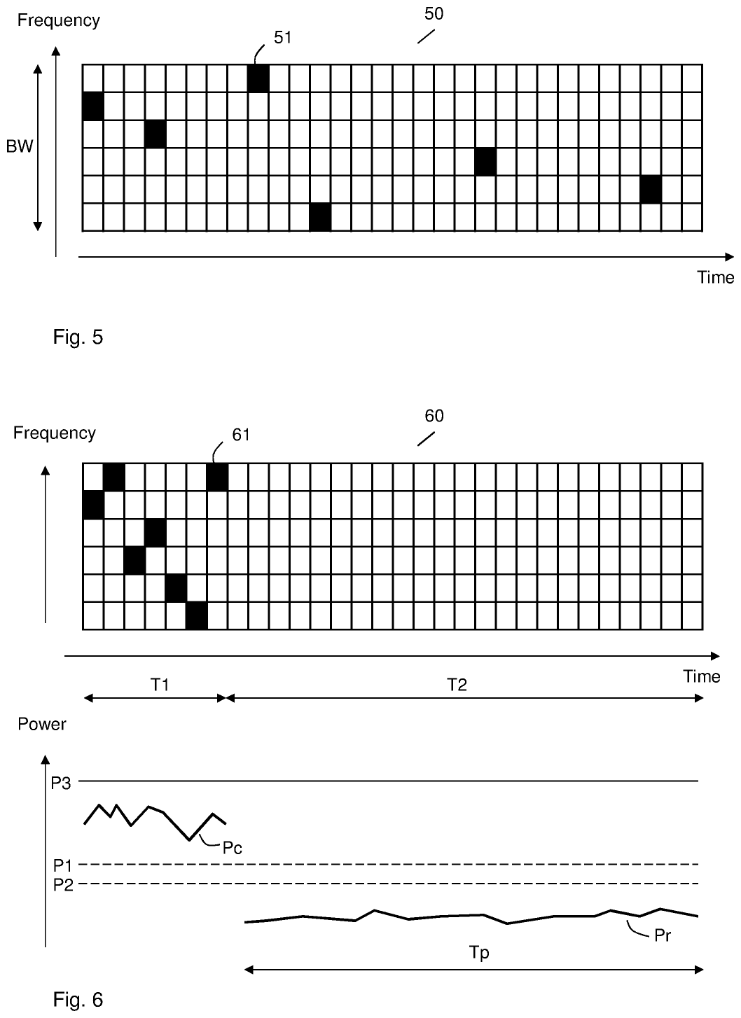

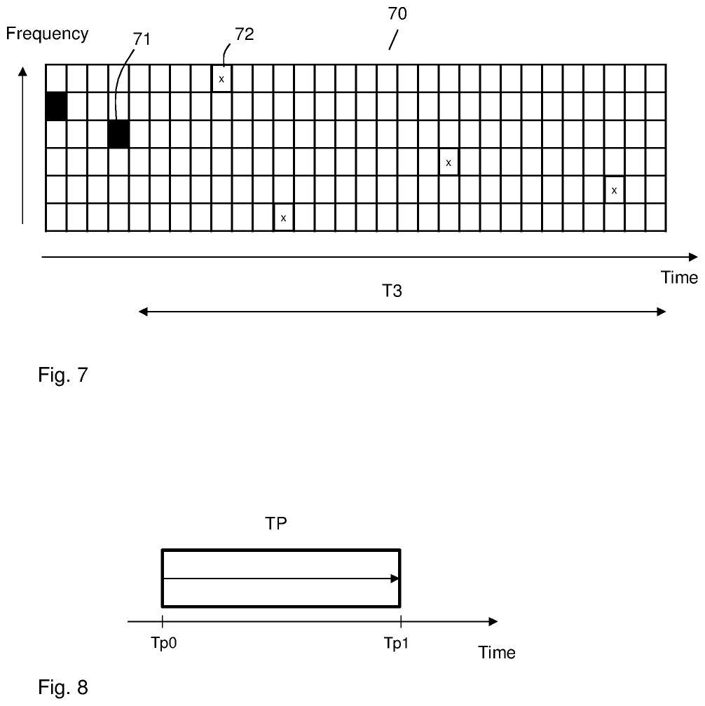

FIG. 5 schematically illustrates a time/frequency diagram of resources available for communication in the wireless system of the network 100, such as between the terminal UE1 and the base station BS1. The shown resource grid 50 may correspond to one defined scheduling time period, such as a frame, a subframe, or some other defined period that may be repeated. In the vertical axis, the bandwidth BW of resources supported or scheduled by the network 100 for use by the wireless chipset 313 is indicated (but is otherwise left out in FIGS. 6 and 7). In various embodiments, the chipset 313 of the terminal may be capable of transmitting within a first bandwidth BWcap, whereas it may be configured by the network 100 to communicate by transmission and reception of communication signals within a predetermined bandwidth BW. As an example, the terminal may be capable of communicating at bands BWcap provided for both 4G and 5G, whereas an access network of the network 100 to which the terminal is connected only provides 4G communication in the bands BW associated thereto. In such an embodiment, the bandwidth BW may form a subset of the first bandwidth BWcap. In such embodiments, the logic may nevertheless be configured to control the chipset 313 to transmit radar signals throughout said first bandwidth BWcap. Since radar probing as such is not carried out in conjunction with the network 100, the full capability of the terminal may be employed even if the network 100 does not support the full scope of the first bandwidth BWcap.

The terminal UE1 may be configured to transmit data or control signals 120 to the network 100, such as the base station BS1, according to a specified or requested manner. In a connected mode, such as RRC_connected, the base station SB1 may control the terminal UE1 to transmit data in the UL. The need for UL transmission of data may also be triggered by the terminal UE1, e.g. in a buffer status report indicating data which the terminal UE1 is desirous to transmit in the UL. Scheduling of resources is normally still executed by the base station BS1 and conveyed to the terminal UE 1.

In the drawing, various resources 51, marked in black, are scheduled for UL transmission from the terminal UE1 to the base station BS1. These resources may take a number of patterns in the time/frequency spectrum, as determined by the base station BS1. In the shown example, these resources 51 are scattered within the shown time period. Since radar probing 130 is executed at a low output power Pr, the radar probing is in various embodiments carried out with repetitious radar signal transmission 140 and reception 150. This may be carried out over said probing period TP, which may include several resource time slots. During that period, the wireless chipset 313 may be configured to inhibit transmission of communication signals in wireless communication system. The reason for this is that data or signal transmission 120 in the UL from the terminal UE1 will be carried out at a power level Pc that may risk saturating the receiver 315 in the wireless chipset 313.

FIG. 6 schematically illustrates a time/frequency diagram for an embodiment in a scenario adapted to allow the terminal UE1 to execute radar probing during an extended undisturbed probing period TP. The logic 310 may be configured to control the wireless communication chipset 313 to transmit a request for radar probing to the network 100 of the wireless communication system, such as to the base station BS1. The base station BS1, to which the terminal UE1 is connected, may determine uplink scheduling adapted to allow for radar probing during said probing period TP without uplink transmission. In the example of FIG. 6, resources 61 scheduled for UL transmission by the terminal UE1 in the of time/frequency grid 60 are configured in a first time period T1, whereas a second time period T2 does not include any scheduled resources for uplink transmission. This way, a portion T2 of the entire cycle period for UL transmission is adapted to be used for radar probing by the terminal UE1 in consecutive time slots. It should be understood that the UL-free time period T2 may be configured in any part of the grid 60, not necessarily as the example shown.

It may be noted that FIG. 6 only shows scheduling of resources for transmission by the terminal, in UL or side link SL. However, in various embodiments, the terminal may be configured to obtain scheduling for reception of communication signals, also in the probing period TP. The chipset 313 may thereby be controlled to receive communication signals, in downlink DL or SL, on the radio channel during the probing period TP. If for example DL data and a radar echo arrive simultaneously at the receiver, the logic 310 controls the chipset 313 to separate the signals in the baseband, and the receiver 315 acting as radar receiver is configured to filter out and ignore the DL data as non-relevant signals. Both received communication data and radar echoes can nevertheless be fully restored. Therefore, DL communication is not a problem and radar operation can be performed simultaneously.

In case a communication signal is received, e.g. in DL, in the terminal, which would trigger the terminal to transmit in return, such as an ACK in UL, the logic 310 may in some embodiments skip or postpone such transmission to after the probing period TP. In other embodiments, the chipset 313 will execute any required transmission as triggered but skip radar probing in the same time slot(s) as the resources used for the communication signal transmission using the chipset 313. In the lower part of FIG. 6, an UL transmit power is indicated as a function of time. It should be understood that the curves indicate examples of power levels upon or configured for signal transmission by the terminal UE1, where the relative difference between UL transmission and radar signal transmission is clearly shown. For UL transmission, in the portion T1, the output power Pc of the terminal UE1 is configured based on specified criteria and calculations made by the terminal UE1 for power management. The transmit power during UL transmission shall exceed a power level or limit P1 and/or P2, which meets or exceeds regulatory demands, e.g. for spurious emissions, and shall furthermore not exceed a second power level or limit P3, determined based on regulatory and specified power requirements. In the drawing, levels P1 and P2 are indicated as different, but that need not be the case, nor does P1 need to exceed P2.

For radar signal transmission 140 during probing, in the probing period TP, which is smaller than or equal to the period T2, and occurs within the period T2, the output power Pr of the terminal UE1 may be configured to not exceed the power level or limit P1, such as one or both of the exemplified power levels P1A or P1B. The radar transmission at power Pr will therefore not be deemed as a radio signal that is in conflict with the wireless communication system and its specified provisions and associated regulations.

FIG. 7 schematically illustrates a time/frequency diagram for an alternative embodiment in a scenario adapted to allow the terminal UE1 to execute radar probing during an extended undisturbed probing period TP. The logic 310 may be configured to control the wireless communication chipset 313 to transmit an indication of radar probing to the network 100 of the wireless communication system, such as to the base station BS1. The base station BS1, to which the terminal UE1 is connected, may determine uplink scheduling adapted to allow for radar probing during said probing period TP without uplink transmission. In the example of FIG. 7, rather than rescheduling the UL resources as in FIG. 6, the base station BS1 is configured to schedule UL resources 71 in the first period T1 but dispense with UL requirement from the terminal UE1 in a period T3. Compared to the scheduling of FIG. 5, in which no radar probing is carried out or planned, corresponding resources 72 in the period T3 are thus not used (marked x) for UL transmission by the terminal UE1. The terminal UE1 is thereby configured to postpone uplink signaling pending said probing period TP. During T3 there are thus no scheduled resources for uplink transmission. This way, the portion T3 of the entire cycle period for UL transmission is adapted to be used for radar probing by the terminal UE1 in consecutive time slots. It should be understood that the UL-free time period T3 may be configured in any part of the grid 60, not necessarily as the example shown.

In a variant of the embodiment of FIG. 7, the terminal UE1 may be allowed to postpone or skip UL traffic during the probing period. This allowance may be conditioned, by specification or by the base station BS1, on that it occurs in the period T3. In such an embodiment, the resources 72 may also be scheduled for UL transmission in the network 100, but the terminal UE1 may determine to postpone UL signaling pending the probing period TP.

With reference to both FIGS. 6 and 7, in a variant of any of these embodiments, one or a few time slots within the second time period T2, T3 may be scheduled for UL transmission, such that at least only a short amount time in the second time period T2, T3 is interrupted by UL transmission. In such an embodiment, the terminal UE1 may make a brief interruption in radar probing during that or those UL resource(s) and then the transmission of repeated radar signals may be resumed with only a very short interruption.

In some embodiments, an indication of radar probing is transmitted as part of radio capability of the terminal. This signals to the network 100 that the terminal UE1 is capable of radar probing at sub P1 power. In some embodiments, the base station BS1 may be configured to apply uplink scheduling to the terminal UE1 based on a request for radar probing received from the terminal. The presence, in one period, such as a frame or subframe, of the entire scheduling time period of the time period T2, T3 may then be signaled from the network 100 to the terminal UE1, e.g. in the attach procedure when the UE capabilities are transmitted. Alternatively, this information may be signaled by the base station BS1 when the terminal UE1 connects to that base station BS1, thus allowing each base station to determine its own scheduling of UL traffic.

In some embodiments, the UE1 may be configured to transmit the request for radar probing responsive to a triggering event in the terminal. The base station BS1 may thereby apply UL scheduling adapted to allow for a probing period uninhibited by UL scheduling, as shown in FIGS. 6 and 7, responsive to receiving the request for radar probing. This request may thus be transmitted as a message by the terminal UE1 in connected mode, or during RRC signaling when requesting connected mode, as a request for radar probing. The request may include an identification of the probing period, e.g. including a requested length of the probing period and/or a starting point of the probing period. Transmission of the request may e.g. be carried out at the time when the terminal is desirous to perform radar probing. This triggering event may e.g. be a proximity sensor or photo sensor signal detecting presence of an object TO, or of a user selection input in the terminal UE1 or by remote activation. The setting of the UL scheduling according to FIG. 6 or 7 may thus be temporary, applied by the base station BS1 for only one period, or an identified or specified number of consecutive periods, such as frames or subframes, of the scheduling time period as shown in FIGS. 5-7.

In some embodiments, the second time period T2, T3 during which terminal transmission is not scheduled by the network is the same as or longer than the radar probing period TP. In another embodiment, the probing period TP is defined by the base station BS1 as the period T2 or T3, or as a function of T2, T3, defining a longest consecutive period of resource time slots in which no UL transmission is scheduled. In various embodiments, the probing period may be dependent on the used bandwidth.

FIG. 8 schematically illustrates the probing period TP for the terminal UE1. Transmission of radar signals commences at a time point Tp0, and is repeatedly carried out until a time point Tp1, which time points mark the start and end of the probing period TP.

In some embodiments, the probing period TP is defined by, or includes, an identification of the start Tp0 of the probing period TP. In one embodiment, start time Tp0 and period time TP, or end time Tp1, may be signaled from the terminal UE1 to the base station BS1, as a part of or in association with a request for being allowed an UL free time period. Alternatively, in an embodiment where the scheduling by the base station BS1 determines the size and or place of the UL free period T2, T3 in the scheduling cycle, the start time Tp0 and period time TP, or end time Tp1, may be signaled from the base station BS1 to the terminal UE1. This way, the base station BS1 may more freely select where the UL free period T2, T3 shall be placed in the scheduling cycle, and possibly also how long it can be allowed to be.

In various embodiments, the probing period TP may thus have a predetermined length, set by terminal UE1 request, or determined dependent on the scheduling by the base station BS1.

In an alternative embodiment, the probing period may be determined based on a quality level of sensing receive properties of reflections of the radar signal. The end Tp1 of the probing period, and hence the length (or number of transmission iterations) of the probing period TP, may thus be determined based on the result of the radar probing. The terminal UE1 may be configured to terminate transmission of radar signals responsive to the quality level meeting a threshold value, e.g. be that enough energy has been detected from the received echoes 150 to make a satisfactory radar measurement, according to some quality assessment, or that a calculated position or velocity of the target object TO is determined with enough quality. In such an embodiment, the end Tp2 of the probing period TP may thus be floating, although confined to a limit such that the probing period falls within the UL free period T2 or T3.

In some embodiments, time duration of the probing period TP can be straightforwardly estimated by standard calculations, such as

(BW*(Power/Hz)*TP/Path_loss/Noise_ower=constant).

As noted, the wireless communication chipset is configured to communicate within a predetermined bandwidth BW. In various embodiments, the logic 310 is configured to control the wireless communication chipset 313 to transmit radar signals 140 within said predetermined bandwidth, which is shared for communication signaling with the network 100. In some embodiments, the wireless communication chipset is configured to transmit a radar signal spanning the chip-set's entire bandwidth. The terminal UE1 may e.g. be an IoT device with small bandwidth BW of e.g. 180 kHz. This way, full use of the wireless communication chipset can be made during the restricted time of the probing period TP.

In various embodiments, the logic 310 is configured to transmit, using the wireless communication chipset 313, radar signal as pseudo-random symbols using orthogonal frequency-division multiplexing, OFDM, and possibly via a spatial filter.

Various embodiments have been outlined herein, aimed at providing improvements in radar probing using a radio communication terminal UE1. By employing radar signal transmission at a low level, corresponding to a noise level or allowed background emission level, the approach enables simultaneous reception of RF communication signals 120, which may be essential in connected mode. In some embodiments, UL transmission it furthermore avoided during radar probing, which allows for radar probing during an extended probing period TP, to accommodate for the low output power, so as to enable collection of sufficient energy from detected radar echoes to make a proper determination of a presence, position, shape, velocity of a target object TO. The radar signal itself may be selected as pseudo-random symbols transmitted using OFDM. The transmitted radar signal 140 can be distributed in time to avoid collision with the RF communication transmit occasions 120 in the UL. In the presented embodiments, a double port solution of the transceiver in the wireless communication chipset 313 may be employed for full duplexing. The proposed solutions provide the benefit of in-band UE1 radar capability without dedicated resources granted from network, in various embodiments. The proposed solutions of various embodiments are implementable by enforcing null time-collision between normal UL traffic and the radar signal.

According to some aspects, solutions are further provided for an access node BS1, as in FIG. 1 and FIG. 3B, in a network 100 of wireless communication system. The access node BS1 may in these aspects be configured to operate and communicate with the terminal UE1 as described herein, for assisting radar probing in the terminal UE 1.

The access node BS1 comprising the wireless transceiver 323 and the logic 320 may configure the terminal UE1 to transmit communication signals according to a first scheme. In this first scheme, the terminal UE1 may be configured to communicate on the described radio channel 120 in the wireless communication system.

The logic 320 may further be configured to detect a request from terminal UE1 to execute radar probing 130 during a probing period TP. Responsive to said request, the logic 320 may configure the terminal UE1 to transmit communication signals according to a second scheme, wherein said second scheme is adapted to allow radar probing by transmission and reception in the terminal during said probing period. With reference to the embodiments outlined for the terminal UE1, radar probing may thereby be allowed at a bandwidth BW or BWcap.

In some embodiment, said second scheme prescribes a period devoid of scheduled transmission of communication signals during said probing period, or a lower transmission rate of communication signals, in the UL or SL, for the radio communication terminal than said first scheme.

In some embodiments, the logic 320 of the access node BS1 transmits, to the terminal UE1, an identification of a scheduled start of said probing period, wherein the access node BS1 takes control over scheduling of the probing period.

Although the invention has been shown and described with respect to certain preferred examples, equivalents and modifications will occur to others skilled in the art upon the reading and understanding of the specification. The present invention includes all such equivalents and modifications and is limited only by the scope of the appended claims.

1. A radio communication terminal configured to act as a radar device, comprising:
a wireless communication chipset including a transmitter and a receiver 4;
logic configured to control the wireless communication chipset to:
communicate on a radio channel in a wireless communication system;
execute radar probing during a probing period, including to transmit a radar signal using the transmitter and sense receive properties of a reflection of the radar signal using the receiver;
inhibit transmission of communication signals from the communication terminal during said probing period; and
receive communication signals on the radio channel during said probing period.

2. The radio communication terminal of claim 1, wherein the logic is configured to control the wireless communication chipset to:
communicate in the wireless communication system with a transmit power exceeding a threshold power level; and
transmit said radar signal with a transmit power) below said threshold power level.

3. The radio communication terminal of claim 1, wherein the wireless communication chipset is capable of transmitting within a first bandwidth and configured by a network of the wireless communication system to transmit communication signals within a predetermined bandwidth which is at least a subset of the first bandwidth, and wherein the logic is configured to control the wireless communication chipset to transmit said radar signal throughout said first bandwidth.

4. The radio communication terminal of claim 3, wherein the logic is configured to control the wireless communication chipset to transmit said radar signal at a plurality of frequencies spanning the entire predetermined bandwidth.

5. The radio communication terminal of claim 3, wherein the logic is configured to transmit said radar signal as pseudo-random symbols using orthogonal frequency-division multiplexing, OFDM.

6. The radio communication terminal of claim 2, wherein said threshold power level does not exceed a limitation for spurious emissions.

7. The radio communication terminal of claim 2, wherein said threshold power level does not exceed a specified transmit OFF power level.

8. The radio communication terminal of claim 1, wherein said wireless communication chipset includes a 2-port radio transceiver, in which a first port acts as said transmitter and a second port acts as said receiver.

9. The radio communication terminal of claim 1, wherein the logic is configured to control the wireless communication chipset to:
transmit, to a network of the wireless communication system, a request for radar probing;
receive, from the network, uplink scheduling adapted to allow for radar probing during said probing period without uplink transmission.

10. The radio communication terminal of claim 9, wherein an indication of radar probing capability is transmitted as part of radio capabilities of the terminal.

11. The radio communication terminal of claim 9, wherein the request for radar probing is transmitted responsive to a triggering event in the terminal.

12. The radio communication terminal of claim 9, wherein the request includes an identification of said probing period.

13. The radio communication terminal of claim 9, wherein the request includes an identification of a start of said probing period.

14. The radio communication terminal of claim 9, wherein the logic is configured to control the wireless communication chipset to:
receive, from the network, an identification of a scheduled start of said probing period.

15. The radio communication terminal of claim 1, wherein the logic is configured to control the wireless communication chipset to:
detect a trigger for transmission, during said probing period, of uplink communication;
postpone uplink transmission pending said probing period.

16. The radio communication terminal of claim 1, wherein the probing period has a predetermined length.

17. The radio communication terminal of claim 1, wherein the logic is configured to control the wireless communication chipset to:
commence radar probing at a start of the probing period;
determine a quality level of receive properties of reflections of the radar signal;
terminate transmission of radar signals responsive to the quality level meeting a threshold value.

18. An access node in a network of wireless communication system, comprising:
a wireless transceiver for communicating with a radio communication terminal,
logic configured to control the wireless transceiver to configure the radio communication terminal to transmit communication signals according to a first scheme;
detect a request, from the radio communication terminal, to execute radar probing during a probing period;
configure the radio communication terminal to transmit communication signals according to a second scheme, responsive said request, wherein said second scheme is adapted to allow radar probing by transmitting a radar signal and sensing receive properties of a reflection of the radar signal using the radio communication terminal during said probing period; and
transmit communication signals to the radio communication terminal during said probing period.

19. The access node of claim 18, wherein said second scheme prescribes a period devoid of scheduled transmission of communication signals from the terminal during said probing period.

20. The access node of claim 18, wherein said second scheme prescribes a lower transmission rate for the radio communication terminal than said first scheme.

21. The access node of claim 18, wherein the logic is configured to control the wireless transceiver to:
transmit, to the radio communication terminal, an identification of a scheduled start of said probing period.
